(19) United States
(12) Patent Application Publication
(10) Pub. No.: US 2004/0128448 A1
(43) Pub. Date: Jul. 1, 2004

(54) Apparatus for memory communication during runahead execution

(75) Inventors: Jared W. Stark, Portland, OR (US); Chris B. Wilkerson, Portland, OR (US); Onur Mutlu, Austin, TX (US)

Correspondence Address: KENYON & KENYON, 1500 K STREET, N.W., SUITE 700, WASHINGTON, DC, 20005, US

(73) Assignee: INTEL CORPORATION

(21) Appl. No.: 10/331,336

(22) Filed: Dec. 31, 2002

(51) Int. Cl. G06F 12/00

(52) U.S. Cl. 711/137; 711/125; 712/207; 712/235

(57) ABSTRACT

Processor architectures, and in particular, processor architectures with a cache-like structure to enable memory communication during runahead execution. In accordance with an embodiment of the present invention, a system including a memory; and an out-of-order processor coupled to the memory. The out-of-order processor including at least one execution unit, at least one cache coupled to the at least one execution unit; at least one address source coupled to the at least one cache; and a runahead cache coupled to the at least one address source.

### FIELD OF THE INVENTION

The present invention relates to processor architectures, and in particular, processor architectures with a cache-like structure to enable memory communication during runahead execution.

### BACKGROUND

Today's high performance processors tolerate long latency operations by implementing out-of-order instruction execution. An out-of-order execution engine tolerates long latencies by moving the long-latency operation “out of the way” of the operations that come later in the instruction stream and that do not depend on it. To accomplish this, the processor buffers the operations in an instruction window, the size of which determines the amount of latency the out-of-order engine can tolerate.

Unfortunately, as a result of the growing disparity between processor and memory speeds, today's processors are facing increasingly larger latencies. For example, operations that cause cache misses out to main memory can take hundreds of processor cycles to complete execution. Tolerating these latencies solely with out-of-order execution has become difficult, as it requires ever-larger instruction windows, which increases design complexity and power consumption. For this reason, computer architects developed software and hardware prefetching methods to tolerate long memory latencies, a few of which are discussed below.

Memory access is a very important long-latency operation that has long concerned researchers. Caches can tolerate memory latency by exploiting the temporal and spatial reference locality of applications. The latency tolerance of caches has been improved by allowing them to handle multiple outstanding misses and to service cache hits in the presence of pending misses.

Software prefetching techniques are effective for applications where the compiler can statically predict which memory references will cause cache misses. For many applications this is not a trivial task. These techniques also insert prefetch instructions into applications, increasing instruction bandwidth requirements.

Hardware prefetching techniques use dynamic information to predict what and when to prefetch. They do not require any instruction bandwidth. Different prefetch algorithms cover different types of access patterns. The main problem with hardware prefetching is the hardware cost and complexity of a prefetcher that can cover the different types of access patterns. Also, if the accuracy of the hardware prefetcher is low, cache pollution and unnecessary bandwidth consumption degrades performance.

Thread-based prefetching techniques use idle thread contexts on a multithreaded processor to run threads that help the primary thread. These helper threads execute code, which prefetches for the primary thread. The main disadvantage of these techniques is that they require idle thread contexts and spare resources (for example, fetch and execution bandwidth), which are usually not available when the processor is well used.

Runahead execution was first proposed and evaluated as a method to improve the data cache performance of a five-stage pipelined in-order execution machine. It was shown to be effective at tolerating first-level data cache and instruction cache misses. In-order execution is unable to tolerate any cache misses, whereas out-of-order execution can tolerate some cache miss latency by executing instructions that are independent of the miss. Similarly, out-of-order execution cannot tolerate long-latency memory operations without a large, expensive instruction window.

A mechanism to execute future instructions when a long-latency instruction blocks retirement has been proposed to dynamically allocate a portion of the register file to a “future thread,” which is launched when the “primary thread” stalls. This mechanism requires partial hardware support for two different contexts. Unfortunately, when the resources are partitioned between the two threads, neither thread can make use of the machine's full resources, which decreases the future thread's benefit and increases the primary thread's stalls. In runahead execution, both normal and runahead mode can make use of the machine's full resources, which helps the machine to get further ahead during runahead mode.

Finally, it has been proposed that instructions dependent on a long-latency operation can be removed from the (relatively small) scheduling window and placed into a (relatively big) waiting instruction buffer (WIB) until the operation is complete, at which point the instructions can be moved back into the scheduling window. This combines the latency tolerance benefit of a large instruction window with the fast cycle time benefit of a small scheduling window. However, it still requires a large instruction window (and a large physical register file), with its associated cost.

### BRIEF DESCRIPTION OF THE DRAWINGS

FIG. 1 is a block diagram of a processing system that includes an architectural state including a processor registers and memory, in accordance with an embodiment of the present invention.

FIG. 2 is a detailed block diagram of an exemplary processor structure for the processing system of FIG. 1 having a runahead cache architecture, in accordance with an embodiment of the present invention.

FIG. 3 is a detailed block diagram of a runahead cache component of FIG. 2, in accordance with an embodiment of the present invention.

FIG. 4 is a detailed block diagram of an exemplary tag array structure for use in the runahead cache of FIG. 1, in accordance with an embodiment of the present invention.

FIG. 5 is a detailed block diagram of an exemplary data array for use in the runahead cache of FIG. 1, in accordance with an embodiment of the present invention.

FIG. 6 is a detailed flow diagram of a method of using a runahead execution mode to prevent blocking in a processor, in accordance with an embodiment of the present invention.

### DETAILED DESCRIPTION

In accordance with an embodiment of the present invention, runahead execution may be used as a substitute for building large instruction windows to tolerate very long latency operations. Instead of moving the long-latency operation “out of the way,” which requires buffering it and the instructions that follow it in the instruction window, runahead execution on an out-of-order execution processor may simply toss it out of the instruction window.

In accordance with an embodiment of the present invention, when the instruction window is blocked by the long-latency operation, the state of the architectural register file may be checkpointed. The processor may then enter a “runahead mode and may distribute a bogus (that is, invalid) result for the blocking operation and may toss it out of the instruction window. The instructions following the blocking operation may then be fetched, executed, and pseudo-retired from the instruction window. “Pseudo-retire” means that the instructions may be executed and completed in the conventional sense, except that they do not update the architectural state. When the long-latency operation that was blocking the instruction window completes, the processor may re-enter “normal mode,” and may restore the checkpointed architectural state and refetch and re-execute instructions starting with the blocking operation.

In accordance with an embodiment of the present invention, the benefit of executing in runahead mode comes from transforming a small instruction window that is blocked by long-latency operations into a non-blocking window, giving it the performance of a much larger window. Instructions may be fetched and executed during runahead mode to create very accurate prefetches for the data and instruction caches. These benefits come at a modest hardware cost, which will be described later.

In accordance with an embodiment of the present invention, only memory operations that miss in a second-level (L2) cache may be evaluated. However, all other embodiments may be initiated on any long-latency operation that blocks the instruction window in a processor. In accordance with an embodiment of the present invention, the processor may be an Intel Architecture 32-bit (IA-32) Instruction Set Architecture (ISA) processor, manufactured by Intel Corporation of Santa Clara, Calif. Accordingly, all microarchitectural parameters (for example, instruction window size) and IPC (Instructions Per Cycle) performance detailed herein are reported in terms of micro-operations. Specifically, in a baseline machine model based on an Intel® Pentium® 4 processor, which has a 128-entry instruction window, the current out-of-order execution engines are usually unable to tolerate long main memory latencies. However, runahead execution, generally, can better tolerate these latencies and achieve the performance of a machine with a much larger instruction window. In general, a baseline machine with realistic memory latency has an IPC performance of 0.52, while a machine with a 100% second-level cache hit ratio has an IPC of 1.26. Adding runahead operation can increase the baseline machine's IPC by 22% to 0.64, which is within 1% of the IPC of an identical machine with a 384-entry instruction window.

In general, out-of-order execution can tolerate cache misses better than in-order execution by scheduling operations that are independent of the miss. An out-of-order execution machine accomplishes this using two windows: an instruction window and a scheduling window. The instruction window may hold all the instructions that have been decoded but not yet committed to the architectural state. The instruction window's main purpose is, generally, to guarantee in-order retirement of instructions to support precise exceptions. Similarly, the scheduling window may hold a subset of the instructions in the instruction window. The scheduling window's main purpose is, generally, to search its instructions each cycle for those that are ready to execute and to schedule them for execution.

In accordance with an embodiment of the present invention, a long-latency operation may block the instruction window until it is completed and, even though subsequent instructions may have completed execution, they cannot retire from the instruction window. As a result, if the latency of the operation is long enough and the instruction window is not large enough, instructions may pile up in the instruction window until it becomes full. At this point the machine may stall and stop making forward progress, since although the machine can still fetch and buffer instructions, it cannot decode, schedule, execute, and retire them.

In general, a processor is unable to make progress while the instruction window is blocked waiting for a main memory access. Fortunately, runahead execution may remove the blocking instruction from the window, fetch the instructions that follow it, and execute those that are independent of it. The performance benefit of runahead execution may come from fetching instructions into the fetch engine's caches and executing the independent loads and stores that miss the first or second level caches. All these cache misses may be serviced in parallel with the miss to main memory that initiated runahead mode, and provide useful prefetch requests. As a result, the processor may fetch and execute many more useful instructions than the instruction window would normally permit. If this is not the case, runahead provides no performance benefit over out-of-order execution

In accordance with embodiments of the present invention, runahead execution may be implemented on a variety of out-of-order processors. For example, in one embodiment, the out-of-order processors may have instructions access the register file after they are scheduled and before they execute. Examples of this type of processor include, but are not limited to, an Intel® Pentium® 4 processor; a MIPS® R10000® microprocessor, manufactured by Silicon Graphics Inc. of Mountain View, Calif.; and an Alpha 21264 processor manufactured by Digital Equipment Corporation of Maynard, Mass. (now Hewlett-Packard Company of Palo Alto, Calif.). In another embodiment, the out-of-order processor may have instructions that access the register file before they are placed in the scheduler, including, for example, an Intel® Pentium® Pro processor, manufactured by Intel Corporation of Santa Clara, Calif. Although the implementation details of runahead execution may be slightly different between the two embodiments, the basic mechanism works the same way.

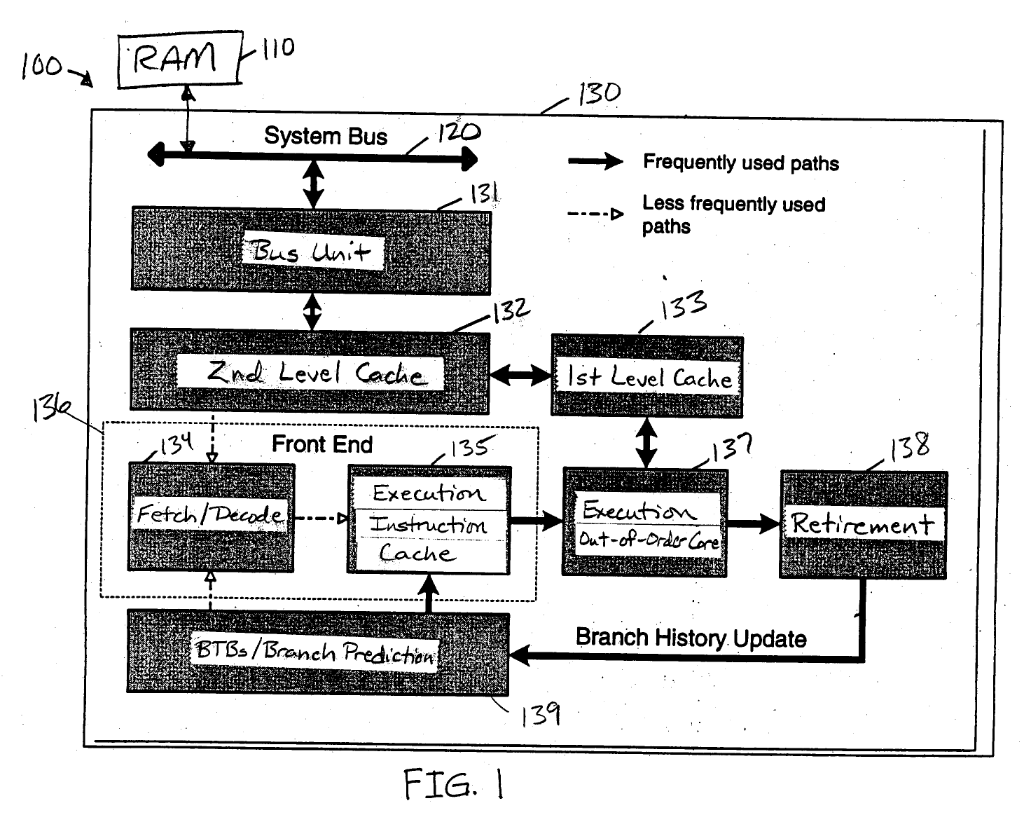

FIG. 1 is a block diagram of a processing system that includes an architectural state including processor registers and memory, in accordance with an embodiment of the present invention. In FIG. 1, a computing system 100 may include a random access memory 110 coupled to a system bus 120, which may be coupled, to a processor 130. Processor 130 may include a bus unit 131 coupled to system bus 120 and coupled to a second-level (L2) cache 132 to permit two-way communications and/or data/instruction transfer between L2 cache 132 and system bus 120. L2 cache 132 may be coupled to a first-level (L1) cache 133 to permit two-way communications and/or data/instruction transfer, and coupled to a fetch/decode unit 134 to permit the loading of the data and/or instructions from L2 cache 132. Fetch/decode unit 134 may be coupled to an execution instruction cache 135 and fetch/decode 134 and execution instruction cache 135 together may be considered a front end 136 of an execution pipeline processor 130. Execution instruction cache 135 may be coupled to an execution core 137, for example, an out-of-order core, to permit the forwarding of data and/or instructions to execution core 137 for execution. Execution core 137 may be coupled to L1 cache 133 to permit two-way communications and/or data/instruction transfer, and may be coupled to a retirement section 138 to permit the transfer of the results of executed instructions from execution core 137. Retirement section 138, in general, processes the results and updates the architectural state of processor 130. Retirement section 138 may be coupled to a branch prediction logic section 139 to provide branch history information of the completed instructions to branch prediction logic section 139 for training of the prediction logic. Branch prediction logic section 139 may include multiple branch target buffers (BTBs) and may be coupled to fetch/decode unit 134 and execution instruction cache 135 to provide a predicted next instruction address to be retrieved from L2 cache 132.

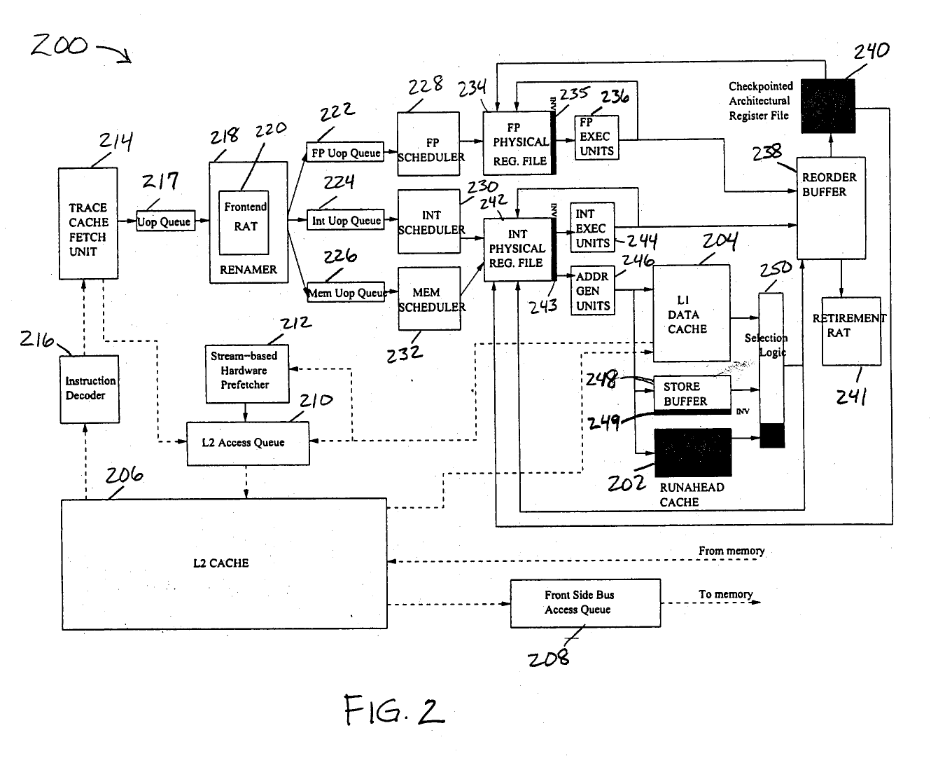

In accordance with an embodiment of the present invention, FIG. 2 shows a stylized out-of-order processor pipeline 200 with a new runahead cache 202. In FIG. 2, the dashed lines show the flow data and signal miss traffic may take in and out of the processor caches, a Level 1 (L1) data cache 204 and a Level 2 (L2) cache 206. In accordance with an embodiment of the present invention, in FIG. 2, shading indicates the processor hardware components required to support runahead execution.

In FIG. 2, a L2 cache 206 may be coupled to a memory, for example, a mass memory (not shown), via a front side bus access queue 208 for L2 cache 206 to send/request data to/from the memory. L2 cache 206 may also be directly coupled to the memory to receive data and signals in response to the sends/requests. L2 cache 206 may be further coupled to a L2 access queue 210 to receive requests for data sent through L2 access queue 210. L2 access queue 210 may be coupled to L1 data cache 204, a stream-based hardware prefetcher 212 and a trace cache fetch unit 214 to receive the requests for data from L1 data cache 204, stream-based hardware prefetcher 212 and trace cache fetch unit 214. Stream-based hardware prefetcher 212 may also be coupled to L1 data cache 204 to receive the requests for data. An instruction decoder 216 may be coupled to L2 cache 206 to receive requests for instructions from L2 cache 206, and coupled to trace cache fetch unit 214 to forward the instruction requests received from L2 cache 206.

In FIG. 2, trace cache fetch unit 214 may be coupled to a micro-operation (stop) queue 217 to forward instruction requests to μop queue 217. μop queue 217 may be coupled to a renamer 218, which may include a front-end Register Alias Table (RAT) 220 that may be used to rename incoming instructions and contain the speculative mapping of architectural registers to physical registers. A floating point (FP) μop queue 222, an integer (Int) μop queue 224 and a memory μop queue 226 may be coupled, in parallel, to renamer 218 to receive appropriate μops. FP μop queue 222 may be coupled to a FP scheduler 228 and FP scheduler 228 may receive and schedule for execution floating point μops from FP μop queue 222. Int μop queue 224 may be coupled to an Int scheduler 230 and Int scheduler 230 may receive and schedule for execution integer μops from Int μop queue 224. Memory μop queue 226 may be coupled to a memory scheduler 232 and memory scheduler 232 may receive and schedule for execution memory μops from memory μop queue 226.

In FIG. 2, in accordance with an embodiment of the present invention, FP scheduler 228 may be coupled to a FP physical register file 234, which may receive and store FP data. FP physical register file 234 may include invalid (INV) bits 235, which may be used to indicate whether the contents of FP physical register file 234 are valid or invalid. FP physical register file 234 may be further coupled to one or more FP execution units 236 and may provide the FP data to FP execution units 236 for execution. FP execution units 236 may be coupled to a reorder buffer 238 and also coupled back to FP physical register file 234. Reorder buffer 238 may be coupled to a checkpointed architectural register file 240, which may be coupled back to FP physical register file 234, and may be coupled to a retirement RAT 241. Retirement RAT 241 may contain pointers to those physical registers that contain committed architectural values. Retirement RAT 241 may be used to recover architectural state after branch mispredictions and exceptions.

In FIG. 2, in accordance with an embodiment of the present invention, Int scheduler 230 and memory scheduler 232 may both be coupled to an Int physical register file 242, which may receive and store integer data and memory address data. Int physical register file 242 may include invalid (INV) bits 243, which may be used to indicate whether the contents of Int physical register file 242 are valid or invalid. Int physical register file 242 may be further coupled to one or more Int execution units 244 and one or more address generation units 246, and may provide the integer data and memory address data to Int execution units 244 and address generation units 246, respectively, for execution. Int execution units 244 may be coupled to reorder buffer 238 and also coupled back to Int physical register file 242. Address generation units 246 may be coupled to L1 data cache 204, a store buffer 248 and runahead cache 202. Store buffer 248 may include an INV bit 249, which may be used to indicate whether the contents of store buffer 248 are valid or invalid. Int physical register file 242 may also be coupled to checkpointed architectural register file 240 to receive architectural state information, and may be coupled to reorder buffer 238 and a selection logic 250 to permit two-way information transfer.

In accordance with other embodiments of the present invention, depending on which type of out-of-order processor the invention is used, the address generation unit may be implemented as a more general address source, such as a register file and/or an execution unit.

In accordance with an embodiment of the present invention, in FIG. 2, processor 200 may enter runahead mode at any time, for example, but not limited to, a data cache miss, an instruction cache miss, and a scheduling window stall. In accordance with an embodiment of the present invention, processor 200 may enter runahead mode when a memory operation misses in a second-level cache 206 and the memory operation reaches the head of the instruction window. When the memory operation reaches (blocks) the head of the instruction window, the address of the instruction may be recorded and runahead execution mode may be entered. To correctly recover the architectural state on exit from runahead mode, processor 200 may checkpoint the state of architectural register file 240. For performance reasons, processor 200 may also checkpoint the state of various predictive structures such as branch history registers and return address stacks. All instructions in the instruction window may be marked as “runahead operations” and treated differently by the microarchitecture of processor 200. In general, any instruction that is fetched in runahead mode may also be marked as a runahead operation.

In accordance with an embodiment of the present invention, in FIG. 2, checkpointing of checkpointed architectural register file 240 may be accomplished by copying the contents of physical registers 234, 242 pointed to by Retirement RAT 241, which may take time. Therefore, to avoid performance loss due to copying, processor 200 may be configured to always update checkpointed architectural register file 240 during normal mode. When a non-runahead instruction retires from the instruction window, it may update its architectural destination register in checkpointed architectural register file 240 with its result. Other check-pointing mechanisms may also be used, and no updates to checkpointed architectural register file may be made during runahead mode. As a result, this embodiment of runahead execution may introduce a second level checkpointing mechanism to the pipeline. Even though Retirement RAT 241, generally, points to the architectural register state in normal mode, it may point to the pseudo-architectural register state during runahead mode and may reflect the architectural state updated by pseudo-retired instructions.

In general, the main complexities associated with the execution of runahead instructions involve memory communication and propagation of invalid results. In accordance with an embodiment of the present invention, in FIG. 2, physical registers 234, 242 may each have an invalid (INV) bit associated with it to indicate whether or not it has a bogus (that is, invalid) value. In general, any instruction that sources a register whose invalid bit is set may be considered an invalid instruction. INV bits may be used to prevent prefetches of invalid data and resolution of branches using the invalid data.

In FIG. 2, for example, if a store instruction is invalid, it may introduce an INV value to the memory image during runahead. To handle the communication of data values (and INV values) through memory during runahead mode, runahead cache 202, which may be accessed in parallel with a level one (L1) data cache 204, may be used.

In accordance with an embodiment of the present invention, in FIG. 2, the first instruction that introduces an INV value may be the instruction that causes processor 200 to enter runahead mode. If this instruction is a load, it may mark its physical destination register as INV. If it is a store, it may allocate a line in runahead cache 202 and mark its destination bytes as INV. In general, any invalid instruction that writes to a register, for example, registers 234, 242 may mark that register as INV after it is scheduled or executed. Similarly, any valid operation that writes to registers 234, 242 may reset the INV bit of the destination register.

In general, runahead store instructions do not write their results anywhere. Therefore, runahead loads that are dependent on invalid runahead stores may be regarded as invalid instructions and dropped. Accordingly, since forwarding the results of runahead stores to runahead loads is essential for high performance, if both the store and its dependent load are in the instruction window, the forwarding may be accomplished, in FIG. 2, through store buffer 248, which, generally, already exists in most current out-of-order processors. However, if a runahead load depends on a runahead store that has already pseudo-retired (that is, the store is no longer in the store buffer), the runahead load may get the result of the store from some other location. One possibility, for example, is to write the result of the pseudo-retired store into a data cache. Unfortunately, this may introduce extra complexity to the design of L1 data cache 204 (and possibly to L2 cache 206, because L1 data cache 204 may need to be modified so that data written by speculative runahead stores may not be used by future non-runahead instructions. Similarly, writing the data of speculative stores into the data cache may also evict useful cache lines. Although another alternative may be to use a large fully associative buffer to store the results of pseudo-retired runahead store instructions, the size and access time of this associative structure may be prohibitively large. In addition, such a structure cannot handle the case where a load depends on multiple stores, without increased complexity.

In accordance with an embodiment of the present invention, in FIG. 2, runahead cache 202 may be used to hold the results and INV status of the pseudo-retired runahead stores. Runahead cache 202 may be addressed just like L1 data cache 204, but runahead cache 202 may be much smaller in size, because, in general, only a small number of store instructions pseudo-retire during runahead mode.

In FIG. 2, although, runahead cache 202 may be called a cache, since it is physically the same structure as a traditional cache, the purpose of runahead cache 202, is not to “cache” data. Instead, runahead cache's 202 purpose is to provide communication of data and INV status between instructions. The evicted cache lines are, generally, not stored back in any other larger storage, rather they may be simply dropped. Runahead cache 202 may be accessed by runahead loads and stores. In normal mode, no instruction may access runahead cache 202. In general, runahead cache may be used to allow:

1. Correct communication of INV bits through memory; and

2. Forwarding of the results of runahead stores to dependent runahead loads.

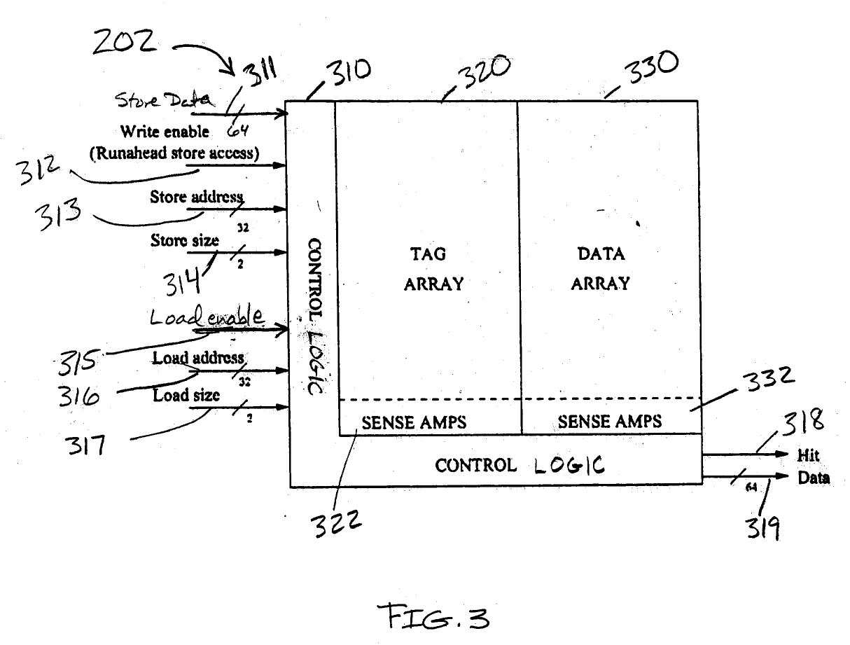

FIG. 3 is a detailed block diagram of a runahead cache component of FIG. 2, in accordance with an embodiment of the present invention. In FIG. 3, runahead cache 202 may include a control logic 310 coupled to a tag array 320 and a data array 330, and tag array 320 may be coupled to data array 330. Control logic 310 may include inputs to couple to a store data line 311, a write enable line 312, a store address line 313, a store size line 314, a load enable line 315, a load address line 316, and a load size line 317. Control logic 310 may also include outputs to couple to a hit signal line 318 and a data output line 319. Tag array 320 and data array 330 may each include sense amps 322, 332, respectively.

In accordance with an embodiment of the present invention, in FIG. 3, store data line 311 may be a 64-bit line, write enable line 312 may be a single bit line, store address line 313 may be a 32-bit line, store size line 314 may be a 2-bit line. Likewise, load enable line 315 may be a 1-bit line, load address line 316 may be a 32-bit line, load size line 317 may be a 2-bit line, hit signal line 318 may be a 1-bit line, and data output line 319 may be a 64-bit line.

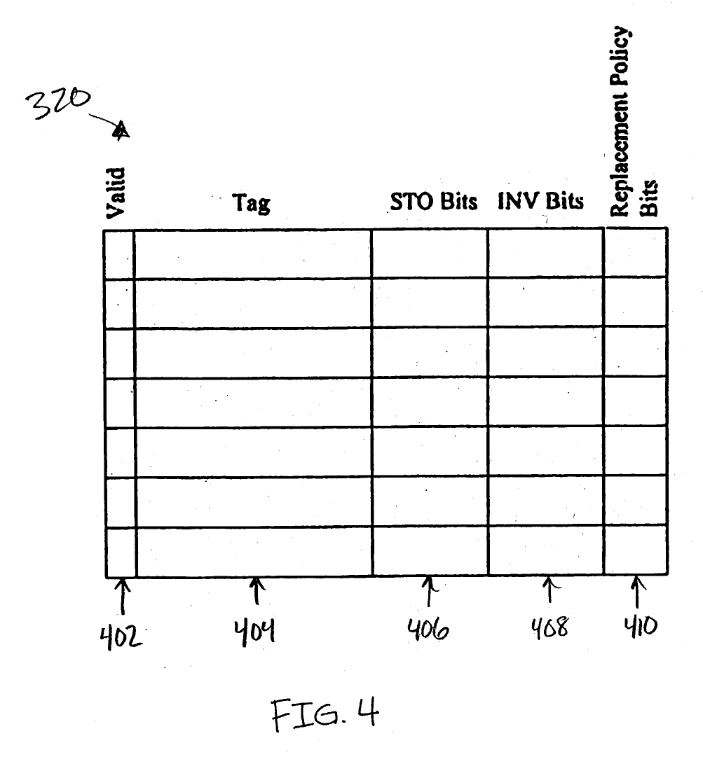

FIG. 4 is a detailed block diagram of an exemplary tag array structure for use in runahead cache 202 of FIG. 3, in accordance with an embodiment of the present invention. In FIG. 4, the data of tag array 320 may include multiple tag array records, each having a valid bit field 402, a tag field 404, a store (STO) bits field 406, an invalid (INV) bits field 408, and a replacement policy bits field 410.

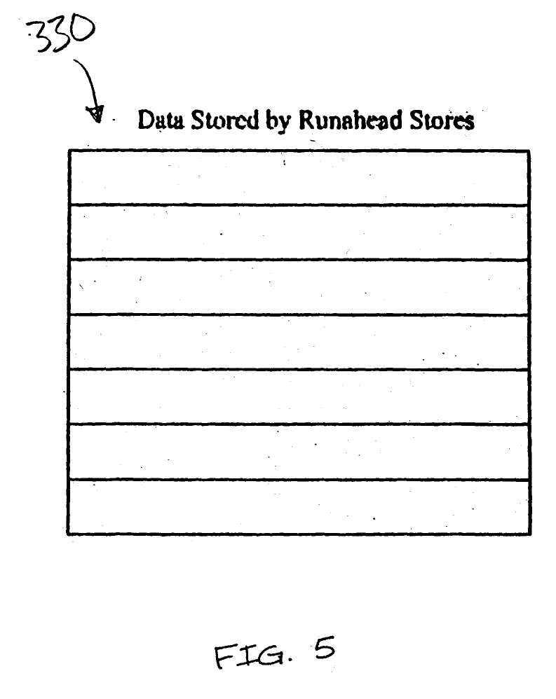

FIG. 5 is a detailed block diagram of an exemplary data array for use in the runahead cache of FIG. 1, in accordance with an embodiment of the present invention. In FIG. 5, data array 330 may include a plurality of n-bit data fields, for example, 32-bit data fields, each of which may be associated with one tag array record.

In accordance with an embodiment of the present invention, to support correct communication of INV bits between stores and loads, each entry in store buffer 248 of FIG. 2 and each byte in runahead cache 202 of FIG. 3 may have a corresponding INV bit. In FIG. 4, each byte in runahead cache 202 may also have another bit (the STO bit) associated with it to indicate whether or not a store has written to that byte. An access to runahead cache 202 may result in a hit only if the accessed byte was written by a store (that is, the STO bit is set) and the accessed runahead cache line is valid. The runahead stores may follow the following rules to update the INV and STO bits and store results:

1. When a valid runahead store completes execution, it may write data into an entry in store buffer 248 (just like in a normal processor) and may reset the associated INV bit of the entry. In the meantime, the runahead store may query L1 data cache 204 and may send a prefetch request down the memory hierarchy if the query misses in L1 data cache 204.

2. When an invalid runahead store is scheduled, it may set the INV bit of its associated entry in store buffer 248.

3. When a valid runahead store exits the instruction window, it may write its result into runahead cache 202, and may reset the INV bits of the written bytes. It may also set the STO bits of the bytes it writes to.

4. When an invalid runahead store exits the instruction window, it may set the INV bits and the STO bits of the bytes it writes into (if its address is valid).

5. Runahead stores may never write their results into L1 data cache 204.

One complication arises when the address of a store operation is invalid. In this case, the store operation may be simply treated as a non-operation (NOP). Since loads are, generally, unable to identify their dependencies on such stores, it is likely that they will incorrectly load a stale value from memory. The problem may be mitigated through the use of memory dependence predictors to identify the dependence between an INV-address store and its dependent load. For example, if predictive structures, such as, store-load dependence prediction, are used to compensate for invalid addresses or values. However, the rules may be different depending on which memory dependence predictors may be used. Once the dependence has been identified, the load may be marked INV if the data value of the store is INV. If the data value of the store is valid, it may be forwarded to the load.

In FIG. 2, in accordance with an embodiment of the present invention, a runahead load operation may be considered invalid for any of the following different reasons:

1. It may source an invalid physical register.

2. It may be dependent on a store that is marked as invalid in the store buffer.

3. It may be dependent on a store that has already pseudo-retired and was invalid.

4. It misses the L2 cache.

Also, in FIG. 2, in accordance with an embodiment of the present invention, a result may be considered invalid if it is produced by an invalid instruction. As a result, a valid instruction is any instruction that is not invalid. Likewise, an instruction may be considered invalid if it sources an invalid result (that is, a register marked as invalid). Consequently, a valid result is any result that is not invalid. In some special cases the rules may change if runahead is entered for any other reason than missing the cache.

In accordance with an embodiment of the present invention, in FIG. 2, the invalid case may be detected using runahead cache 202. When a valid load executes, it may access the following three structures in parallel: L1 data cache 204, runahead cache 202, and store buffer 248. If the load hits in store buffer 248 and the entry it hits is marked valid, the load may receive data from the store buffer. However, if the load hits in store buffer 248 and the entry is marked INV, the load may mark its physical destination register as INV.

In accordance with an embodiment of the present invention, in FIG. 2, a load may be considered to hit in runahead cache 202 only if the cache line it accesses is valid and the STO bit of any of the bytes it accesses in the cache line is set. If the load misses in store buffer 248 and hits in runahead cache 202, it may check the INV bits of the bytes it is accessing in runahead cache 202. The load may execute with the data in runahead cache 202 if none of the INV bits are set. If any of the sourced data bytes is marked INV, then the load may mark its destination INV.

In FIG. 2, in accordance with an embodiment of the present invention, if the load misses in both store buffer 248 and runahead cache 202, but hits in L1 data cache 204, it may use the value from L1 data cache 204 and is considered valid. Nevertheless, the load may actually be invalid, since it may be: 1) dependent on a store with an INV address, or 2) dependent on an INV store which marked its destination bytes in the runahead cache as INV, but the corresponding line in the runahead cache was deallocated due to a conflict. However, both of these are rare cases that do not affect performance significantly.

In FIG. 2, in accordance with an embodiment of the present invention, if the load misses in all three structures, it may send a request to L2 cache 206 to fetch its data. If this request hits in L2 cache 206, data may be transferred from L2 cache 206 to L1 cache 204 and the load may complete its execution. If the request misses in L2 cache 206, the load may mark its destination register as INV and may be removed from the scheduler, just like the load that caused entry into runahead mode. The request may be sent to memory like a normal load request that misses the L2 cache 206.

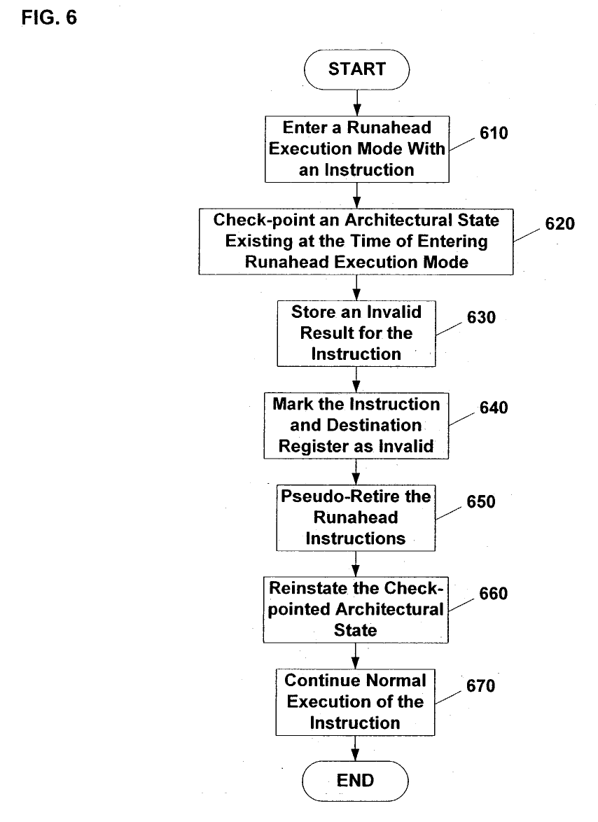

FIG. 6 is a detailed flow diagram of a method of using a runahead execution mode to prevent blocking in a processor, in accordance with an embodiment of the present invention. In FIG. 6, a runahead execution mode may be entered (610) for a data cache miss instruction in, for example, out-of-order execution processor 200 of FIG. 2. Returning to FIG. 6, the architectural state existing when runahead execution mode that is entered may be checkpointed (620), that is, saved, in, for example, checkpointed architectural register file 240 of FIG. 2. Again in FIG. 6, an invalid result for the instruction may be stored (630) in, for example, physical registers 234, 242 of FIG. 2. Returning to FIG. 6, the instruction may be marked (640) as invalid in the instruction window and a destination register of the instruction may also be marked (640) as invalid. Each runahead instruction may be pseudo-retired (650) when it reaches the head of the instruction window of, for example, processor 200 of FIG. 2, by retiring the runahead instruction without updating the architectural state of processor 200. Again in FIG. 6, the checkpointed architectural state may be reinstated (660) when the data for the instruction that caused the data cache miss returns from memory, for example, returns from RAM 110 of FIG. 1. In FIG. 6, execution of the instruction may be continued (670) in normal mode in, for example, processor 200 of FIG. 2.

Branches may be predicted and resolved in runahead mode exactly the same way they are in normal mode except for one difference: a branch with an INV source, like all branches, may be predicted and may update the global branch history register speculatively, but, unlike other branches, it may never be resolved. This may not be a problem if the branch is correctly predicted. However, if the branch is mispredicted, processor 200 will generally be on the wrong path after the fetch of this branch until it hits a control-flow independent point. The point in the program where a mispredicted INV branch is fetched may be referred to as the “divergence point.” Existence of divergence points may not be necessarily bad for performance, but the later they occur in runahead mode, the better the performance improvement.

One interesting issue with branch prediction is the training policy of the branch predictor tables during runahead mode. In accordance with an embodiment of the present invention, one option may be to always train the branch predictor tables. If a branch executes in runahead mode first and then in normal mode, such a policy may result in the branch predictor being trained twice by the same branch. Hence, the predictor tables may be strengthened and the counters may lose their hysteresis, that is, the ability to control changes in the counters based on directional momentum. In an alternate embodiment, a second option may be to never train the branch predictor in runahead mode. In general, this may result in lower branch prediction accuracy in runahead mode, which may degrade performance and move the divergence point closer in time to runahead entry point. In another alternate embodiment, a third option may be to always train the branch predictor in runahead mode, but also to use a queue to communicate the results of branches from runahead mode to normal mode. The branches in normal mode may be predicted using the predictions in this queue, if a prediction exists. If a branch is predicted using a prediction from the queue, it does not train the predictor tables again. In yet another alternate embodiment, a fourth option may be to use two separate predictor tables for runahead mode and normal mode and to copy the table information from normal mode to runahead mode on runahead entry. The fourth option may be costly to implement in hardware. The first option—training the branch predictor table entries twice, in general, does not show significant performance loss compared to the fourth option.

During runahead mode, instructions may leave the instruction window in program order. If an instruction reaches the head of the instruction window it may be considered for pseudo-retirement. If the instruction considered for pseudo-retirement is INV, it may be moved out of the window immediately. If it is valid, it may need to wait until it is executed (at which point it may become INV) and its result is written into the physical register file. Upon pseudo-retirement, an instruction may release all resources allocated for its execution.

In accordance with an embodiment of the present invention, in FIG. 2, both valid and invalid instructions may update Retirement RAT 241 when they leave the instruction window. Retirement RAT 241 may not need to store INV bits associated with each register, because physical registers 234, 242 already have INV bits associated with them. However, in a microarchitecture where instructions access the register file before they are scheduled, the Retirement Register File may need to store INV bits.

When an INV branch exits the instruction window, the resources allocated for the recovery of that branch, if any are deallocated. This is essential for the progress of runahead mode without stalling due to insufficient branch checkpoints.

In accordance with an embodiment of the present invention, Table 1 shows a sample code snippet and explains the behavior of each instruction in runahead mode. In the example, instructions are already renamed and operate on physical registers.

TABLE 1

| Instructions | Explanation |
|---|---|
| 1: load_word p1 <-mem[p2] | second level cache miss, |
| | enter runahead, sets p1 INV |
| 2: add p3 <-p1, p2 | sources INV p1, sets p3 INV |
| 3: store_word mem[p4] <-p3 | sources INV p3, sets its |
| | store buffer entry INV |
| 4: add p5 <-p4, 16 | valid operation, executes |
| | normally, resets p5's INV bit |
| 5: load_word p6 <-mem[p5] | valid load, misses data cache, |
| | store buffer, runahead cache, |
| | misses L2 cache, sends fetch request |
| | for Address (p5), sets p6 INV |
| 6: branch_eq p6, p5, | branch with an INV source p6, |
| (eip + 60) | correctly predicted as taken trace cache |
| | miss - uops 1-6 exit the |
| | instruction window |
| | while the miss is satisfied when they exit |
| | the window, uops 1-6 update the |
| | retirement RAT uop 3 allocates a runahead |
| | cache line at address p4 and sets the STO |
| | and INV bits of 4 bytes |
| | starting at address p4 |
| | recovery resources allocated for uop 6 are |
| | freed upon its pseudo-retirement trace |
| | cache miss is satisfied from L2 |
| 7: load_word p7 <- mem[p4] | miss in store buffer, hit in runahead cache, |
| | check INV bits of addr. p4, sets p7 INV |
| 8: store_word mem[p7] <-p5 | INV address store sets its store buffer |
| | entry INV, all loads after this can alias |
| | without knowing |

In accordance with an embodiment of the present invention, an exit from runahead mode may be initiated at any time. For simplicity, the exit from runahead mode may be handled the same way a branch misprediction is handled. Specifically, all instructions in the machine may be flushed and their buffers may be deallocated. Checkpointed architectural register file 240 may be copied into predetermined portions of physical register files 234, 242. Fronted RAT 220 and retirement RAT 241 may also be repaired to point to the physical registers that hold the values of the architectural registers. This recovery may be accomplished by reloading the same hard-coded mapping into both of the alias tables. All lines in runahead cache 202 may be invalidated (and STO bits may be set to 0), and the checkpointed branch history register and return address stack may be restored upon exit from runahead mode. Processor 200 may start fetching instructions beginning with the address of the instruction that caused entry into runahead mode.

In accordance with an embodiment of the present invention, in FIG. 2, the policy may be to exit from runahead mode when the data of the blocking load request returns from memory. An alternative policy is to exit some time earlier using a timer so that a portion of the pipeline-fill penalty or window-fill penalty is eliminated. Although the exiting early alternative performs well for some benchmarks and badly for others, overall, exiting early may perform slightly worse. The reason exiting early may perform worse for some benchmarks is that more L2 cache 206 miss prefetch requests may be generated than if processor 200 does not exit from runahead mode early. A more aggressive runahead implementation may dynamically decide when to exit from runahead mode, since some benchmarks may benefit from staying in runahead mode even hundreds of cycles after the original L2 cache 206 miss returns from memory.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A system comprising:
a memory; and
an out-of-order processor coupled to said memory, said out-of-order processor including:
at least one execution unit;
at least one cache coupled to said at least one execution unit;
at least one address source coupled to said at least one cache; and
a runahead cache coupled to said at least one address source.

2. The system of claim 1 wherein said address source comprises:
an address generation unit.

3. The system of claim 1 wherein said runahead cache comprises:
a control component;
a tag array coupled to said control component; and
a data array coupled to said tag array and said control component.

4. The system of claim 3 wherein said control component comprises:
a write port including:
a write enable input;
a store data input;
a store address input; and
a store size input;
a read port including:
a load enable input;
a load address input; and
a load size input; and
an output port including:
a hit signal output; and
a data output.

5. The system of claim 3 wherein said tag array comprises:
a plurality of tag array records, each tag array record including:
a valid field;
a tag field;
a store bits field;
a invalid bits field; and
a replacement policy bits field.

6. The system of claim 5 wherein said data array comprises:
a plurality of data records, each data record including:
a data field.

7. The system of claim 1 wherein said at least one cache comprises a level-one cache coupled to said at least one address source.

8. The system of claim 7 wherein said at least one cache further comprises a level-two cache coupled to said level-one cache.

9. The system of claim 1 further comprising a bus coupled to said memory and said out-of-order processor.

10. The system of claim 9 wherein said runahead cache comprises:
a control component to control store and load requests to said runahead cache and data output from said runahead cache;
a tag array coupled to said control component, said tag array to store a plurality of tag array records; and
a data array coupled to said tag array and said control component, said data array to store a plurality of data records, each associated with one of said plurality of tag array records.

11. The system of claim 10 wherein said control component comprises:
a write enable input to permit a runahead instruction data record to be stored in said runahead cache;
a store data input to provide the data record to be stored;
a store address input to receive said runahead instruction data record and an address at which to store said runahead instruction data record; and
a store size input to receive a size of said runahead instruction data record.

12. The system of claim 10 wherein said control component comprises:
a load enable input to permit a load of a runahead instruction data record from said runahead cache;
a load address input to receive a requested address from which to load said runahead instruction data record;
a load size input to receive a size of said requested runahead instruction data record;
a hit signal output to output a signal to indicate whether said requested runahead instruction data record is in the runahead cache; and
a data output to output said runahead instruction data record, if said requested runahead instruction data record is in the runahead cache.

13. A processor comprising:
at least one execution unit;
at least one cache coupled to said at least one execution unit; and
a runahead cache coupled to said at least one execution unit, said runahead cache being configured to be used by instructions being executed in a runahead execution mode to prevent their interaction with any architectural state in said processor.

14. The processor of claim 13 wherein said runahead cache comprises:
a control component;
a tag array coupled to said control component; and
a data array coupled to said tag array and said control component.

15. The processor of claim 14 wherein said control component comprises:
a write port including:
a write enable input;
a store data input;
a store address input; and
a store size input;
a read port including:
a load enable input;
a load address input; and
a load size input; and
an output port including:
a hit signal output; and
a data output.

16. The processor of claim 14 wherein said tag array comprises:
a plurality of tag array records, each tag array record including:
a valid field;
a tag field;
a store bits field;
a invalid bits field; and
a replacement policy bits field.

17. The processor of claim 16 wherein said data array comprises:
a plurality of data records, each data record including:
a data field.

18. The processor of claim 13 wherein said at least one cache comprises a level-one cache coupled to said at least one address generation unit.

19. The processor of claim 18 wherein said at least one cache further comprises a level-two cache coupled to said level-one cache.

20. The processor of claim 13 wherein said runahead cache comprises:
a control component to control store and load requests to said runahead cache and data output from said runahead cache;
a tag array coupled to said control component, said tag array to store a plurality of tag array records; and
a data array coupled to said tag array and said control component, said data array to store a plurality of data records, each associated with one of said plurality of tag array records.

21. A method comprising:
entering a runahead execution mode from a normal execution mode of an instruction in an out-of-order processor;
checkpointing the architectural state existing upon entering runahead execution mode;
storing an invalid result into a physical register file associated with the instruction;
marking the instruction and a destination register associated with the instruction as being invalid;
pseudo-retiring any runahead instructions that reach the head of an instruction window;
reinstating the check-pointed architectural state upon the return of data for the instruction; and
continuing executing the instruction in the normal execution mode.

22. The method as defined in claim 21 wherein said entering operation occurs upon arrival at the head of an instruction window of the instruction with a pending long latency operation.

23. The method as defined in claim 21 wherein said entering operation occurs upon arrival at the head of an instruction window of the instruction, which caused a data cache miss.

24. The method as defined in claim 21 further comprising:
executing subsequent instructions that depend on the instruction in said runahead execution mode.

25. The method as defined in claim 24 wherein said subsequent instructions executing in the runahead execution mode use a temporary memory image.

26. The method as defined in claim 21 wherein said pseudo-retiring operation comprises:
retiring any runahead instructions that reach the head of the instruction window without updating the architectural state.

27. A machine-readable medium having stored thereon a plurality of executable instructions to perform a method comprising:
entering a runahead execution mode from a normal execution mode of an instruction in an out-of-order processor;
checkpointing the architectural state existing upon entering runahead execution mode;
storing an invalid result into a physical register file associated with the instruction;
marking the instruction and a destination register associated with the instruction as being invalid;
pseudo-retiring any runahead instructions that reach the head of an instruction window;
reinstating the check-pointed architectural state upon the return of data for the instruction; and
continuing executing the instruction in the normal execution mode.

28. The machine-readable medium as defined in claim 27 wherein said entering operation occurs upon arrival at the head of an instruction window of the instruction with a pending long latency operation.

29. The machine-readable medium as defined in claim 27 wherein said entering operation occurs upon arrival at the head of an instruction window of the instruction, which caused a data cache miss.

30. The machine-readable medium as defined in claim 27 wherein the method further comprises:
executing subsequent instructions that depend on the instruction in the runahead execution mode.

31. The machine-readable medium as defined in claim 27 wherein said subsequent instructions executing in the runahead execution mode use a temporary memory image.

32. The machine-readable medium as defined in claim 27 wherein said pseudo-retiring operation comprises:
retiring any runahead instructions that reach the head of the instruction window without updating the architectural state.

33. A system comprising:
a memory;
an execution unit including a memory address source coupled to said memory;
a runahead cache coupled to said memory address source;
a plurality of instructions to be executed by said execution unit;
means for entering a runahead execution mode in response to a first predetermined event;
means for exiting said runahead execution mode in response to a second predetermined event; and
said runahead cache to record information produced during said runahead execution mode.

34. The system of claim 33 wherein said memory address source is to produce memory addresses.

35. The system of claim 33 wherein said information produced during said runahead execution mode comprises:
a data value.

36. The system of claim 33 wherein said information produced during said runahead execution mode comprises:
an invalid bit value.
